(19) United States
(12) Patent Application Publication
(10) Pub. No.: US 2021/0348653 A1
(43) Pub. Date: Nov. 11, 2021

(54) BEARING UNIT WITH ECCENTRIC CLAMPING COLLAR

(71) Applicant: Aktiebolaget SKF, Goteborg (SE)

(72) Inventors: Fausto Baracca, Massa (IT); Ettore Bertelloni, Massa (IT); Andrea A. Bertolini, Carrara (IT); Fabio Cavacece, Massa (MS) (IT); Fabio Falaschi, Carrara (IT); Pasquale Frezza, Aversa (CE) (IT)

(21) Appl. No.: 17/245,054

(22) Filed: Apr. 30, 2021

(30) Foreign Application Priority Data
May 6, 2020 (IT) 102020000009982

(51) Int. Cl. F16C 35/073; F16C 35/063

(52) U.S. Cl. CPC F16C 35/073; F16C 2226/16; F16C 35/0635

(57) ABSTRACT

A bearing unit having a stationary radially outer ring, a radially inner ring rotatable around a central rotation axis (Y) of the bearing unit, at least one row of rolling elements interposed between the radially outer ring and the radially inner ring, an eccentric collar for clamping the radially inner ring on a rotating shaft (S), and a first pressure screw on the eccentric collar, wherein the eccentric collar is provided with a second pressure screw which increases the gripping capacity of the bearing unit on the rotating shaft (S).

### CROSS-REFERENCE RELATED APPLICATION

This application is based on and claims priority to Italian Patent Application No. 102020000009982 filed on May 6, 2020, under 35 U.S.C. § 119, the disclosure of which is incorporated by reference herein.

### FIELD

The present disclosure relates to a bearing unit provided with a collar for clamping the radially inner ring on a rotating shaft.

### BACKGROUND

There are known bearing units provided with rolling elements and systems for clamping the unit on a rotating shaft.

Bearing units are used to allow the relative movement of a component or assembly with respect to another component or assembly. The bearing unit typically has a first component, for example a radially inner ring, which is fixed to a first component, for example a rotating shaft, and a second component, for example a radially outer ring, which is fixed to a second component, for example a stationary housing. Typically, as in the aforementioned examples, the radially inner ring is rotatable, while the radially outer ring is stationary, but in many applications the outer element rotates and the inner element is stationary. In any case, in rolling bearing units, the rotation of one ring with respect to the other is allowed by a plurality of rolling elements that are positioned between the cylindrical surface of one component and the cylindrical surface of the second component, these surfaces usually being called raceways. The rolling elements may be balls, cylindrical or tapered rollers, needle rollers, or similar rolling elements.

### BRIEF DESCRIPTION OF THE DRAWINGS

Embodiments in accordance with the disclosure will now be described with reference to the attached drawings, which show some non-limiting examples of such embodiments of a housing element.

FIG. 1 shows, in cross section, an exemplary bearing unit provided with an eccentric clamping collar according to various embodiments,

FIG. 2 is a frontal section through the bearing unit provided with a collar of FIG. 1, in which the clamping means of the collar are visible,

FIG. 3 shows, in cross section, the eccentric clamping collar of the bearing unit of FIG. 1,

FIG. 4 is a frontal section through the eccentric clamping collar of the bearing unit of FIG. 1,

FIG. 5 shows, in cross section, the bearing unit of FIG. 1 assembled on a rotating shaft, and

FIG. 6 is a frontal section through the assembly of FIG. 5.

### DETAILED DESCRIPTION

A bearing unit in accordance with this disclosure is suitable for applications in the manufacturing sector and especially in the agricultural sector, since it is simple and economical to produce. In particular, the bearing unit according to the present disclosure is provided with rolling elements and has an optimized clamping system providing for the use of an eccentric clamping collar that can simultaneously lock both the shaft and the radially inner ring, thus causing the two components to be fixed with respect to each other.

Bearing units having a clamping collar for mounting on a rotating shaft is simpler and more economical than one providing for the forced interference coupling of the radially inner ring to the rotating shaft. A known solution is that of using an eccentric clamping collar provided with a pressure screw that grips the rotating shaft. At the same time, when the collar is rotated through a certain angle, the eccentric shape of the collar causes a cylindrical contact surface to be created between the collar and the rotating shaft and also between the collar and the radially inner ring, so as to make the rotating shaft, the clamping collar, and the radially inner ring of the bearing unit, respectively, fixed with respect to each other.

However, the use of the eccentric clamping collar has drawbacks, due to the noise generated and the excessive vibrations that may damage the shaft on which they are fitted.

Furthermore, in heavy-duty applications where high levels of power are to be transmitted, the gripping performance between the three components (shaft, collar, and inner ring) is inadequate. In such conditions, it is possible that the clamping collar may even become disengaged and dismounted from the radially inner ring. This may occur for various reasons, for example in the case of vibrations, high loads, high-performance applications, or the like.

Finally, the eccentric clamping collar provided with a pressure screw is unsuitable for applications in which the rotating shaft may operate in both directions of rotation. In such situations, it is preferable to use a solution without a clamping collar, according to which the radially inner ring is locked directly on to the rotating shaft by means of a pair of pressure screws. This solution also has drawbacks, since it complicates the machining of the radially inner ring.

Consequently there is a need to design a bearing unit provided with a clamping collar such that the clamping is reliable in terms of mechanical strength, while avoiding the generation of excessive noise and/or vibration and being affordable in financial terms.

The object of the present disclosure is to provide bearing units comprising a clamping collar that has characteristics that make the clamping more effective, thus being free of the drawbacks described above. In particular, the collar is an innovative eccentric clamping collar provided with two pressure screws arranged at a predetermined angular spacing which is advantageously between 57° and 67°, or even more preferably equal to 62°.

In order to increase the gripping capacity of the bearing unit on the shaft as compared with the known solutions, another pressure screw has been added to the eccentric clamping collar, according to precise dimensional parameters, as will be apparent from the following detailed description of the embodiments of the disclosure.

Therefore, according to the present disclosure bearing units that overcome the deficiencies described above are produced with an eccentric clamping collar for clamping the radially inner ring.

Embodiments of a bearing unit according to the present disclosure are described below, purely by way of example, with reference to the aforesaid figures.

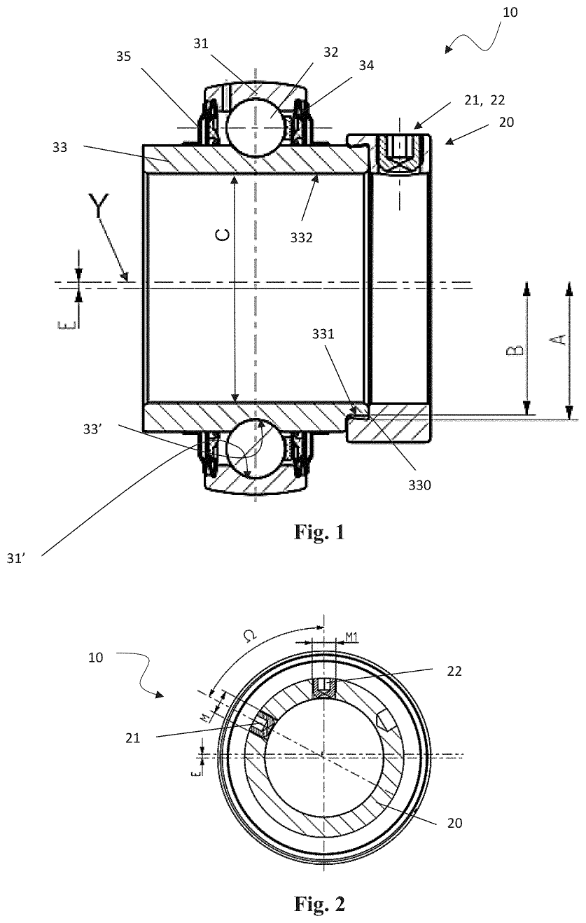

With particular reference to FIG. 1, the bearing unit 10 may be interposed, for example, between a rotating shaft and a housing element. An exemplary bearing unit, e.g., bearing unit 10, includes a stationary radially outer ring 31, a radially inner ring 33, rotatable about a central axis of rotation Y of the bearing unit 10, at least one row of rolling elements 32, in this example balls, interposed between the radially outer ring 31 and the radially inner ring 33, a cage 34 for containing the rolling bodies, in order to keep the rolling elements of the row of rolling bodies 32 in position, an eccentric clamping collar 20 for locking the radially inner ring 33 on to a rotating shaft.

Such bearing units are generally applicable, but are particularly suited for applications in the agricultural sector and/or in manufacturing industry—for example, the textile, mining, motor vehicle, or food industry.

Throughout the present description and the claims, terms and expressions indicating positions and orientations such as “radial” and “axial” are to be interpreted as relative to the central axis of rotation Y of the bearing unit 30.

A radially outer ring 31 is provided with a radially outer raceway 31′, while the radially inner ring 33 is provided with at least one radially inner raceway 33′ to allow the rolling of the row of rolling elements 32 interposed between the radially outer ring 31 and the radially inner ring 33. For simplicity of illustration, the reference 32 will be applied both to the individual balls and to the row of balls. Also for simplicity, the term “ball” may be used by way of example in the present description and in the attached drawings in place of the more generic term “rolling element” (and the same reference numerals will also be used). Some examples of embodiments and the corresponding designs may provide for the use of rolling elements other than balls (rollers, for example), without thereby departing from the scope of the present disclosure.

The bearing unit 10 is also provided with sealing means 35 for sealing the bearing unit from the external environment. Sealing means may be, for example, a seal 35.

A bearing unit in accordance with this disclosure, e.g., 10, comprises an innovative eccentric clamping collar 20, provided with two pressure screws 21, 22 which exert a pressure force, and therefore a gripping force, on a rotating shaft S. Therefore, the eccentric clamping collar 20 serves to clamp the radially inner ring 33 on the rotating shaft S, making these two elements fixed with respect to rotation. The two pressure screws 21, 22 are arranged at a predetermined angular spacing Ω which is advantageously between 57° and 67°, or even more preferably equal to 62°. The use of a second pressure screw is intended to increase the gripping capacity of the bearing unit 10 on the rotating shaft S.

In order to lock the rotating shaft S with respect to the eccentric clamping collar 20 and therefore with respect to the radially inner ring, the clamping collar and the radially inner ring must have certain distinctive geometrical and dimensional features.

In fact, with reference to FIGS. 1 and 2, a radially inner ring, e.g., 33 comprises an end edge 330 having a circumferentially variable thickness, since its said end edge 330 is worked by machining its radially outer cylindrical surface 331 to a diameter B having an eccentricity E with respect to the axis of rotation Y of the bearing unit 10. Preferably, the eccentricity E is between 3% and 4% of the diameter C of the radially inner cylindrical surface 332 of the radially inner ring 33.

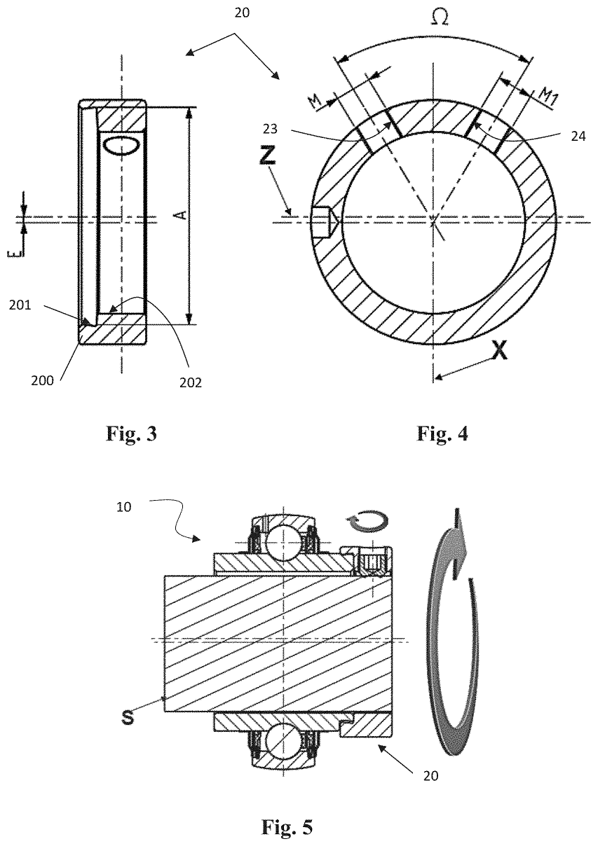

Additionally, with reference to FIGS. 3 and 4, the eccentric clamping collar 20 has an end edge 200 having a circumferentially variable thickness, since said end edge 200 is worked by machining so its radially inner cylindrical surface 201 has a diameter A having the same eccentricity E with respect to the axis of rotation Z of the eccentric clamping collar 20. The value of the eccentricity E is therefore the same for both the radially outer cylindrical surface 331 of the radially inner ring 33 and the radially inner cylindrical surface 201 of the eccentric clamping collar 20.

An eccentric clamping collar in accordance with this disclosure, e.g., 20, has two threaded holes 23, 24 having diameters M and Ml, preferably equal to each other, positioned at an angular spacing Ω. The two pressure screws 21, 22 are screwed into these threaded holes. As stated above, the angular spacing Ω is between 57° and 67°, or even more preferably equal to 62°. Preferably each hole 23, 24 may be at an angular spacing of 31° from a vertical axis X of the eccentric clamping collar 20. The angular position of the holes 23, 24 for the pressure screws 21, 22 according to the present disclosure is therefore symmetrical about vertical axis X, which is perpendicular to the direction of eccentricity E. In some embodiments, as one will appreciate, any suitable two fasteners for applying pressure according to the angular spacing described in the foregoing paragraph may be used and such fasteners may be other pressure screws in combination threaded holes.

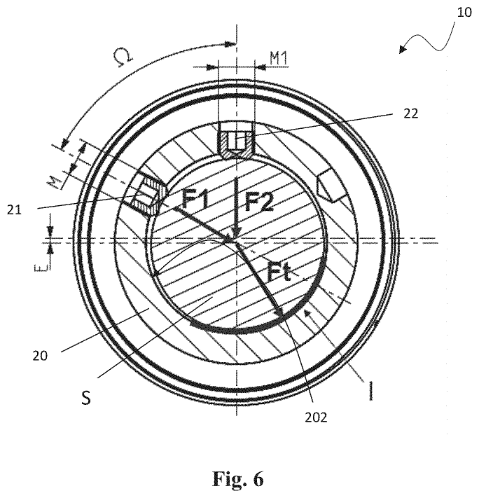

The assembly procedure is very simple. With reference to FIGS. 5 and 6, it is simply necessary to make the radially inner cylindrical surface 201 of the eccentric clamping collar 20 rest on the radially outer cylindrical surface 331 of the radially inner ring 33, and then to make the clamping collar 20 rotate until it interferes with the rotating shaft S, creating an area of contact I between a radially inner cylindrical surface 202 of the eccentric clamping collar 20 and the rotating shaft S. Finally, two pressure screws 21, 22, which will grip the rotating shaft S, are to be tightened. Two pressure screws 21, 22 must be positioned exactly opposite the contact area I with a predetermined angular spacing Ω (of between 57° and 67°, as mentioned above) in such a way that the resultant Ft of the two forces F1 and F2 generated by the pressure screws 21, 22 is always within the contact area I, thus making the coupling between the rotating shaft S and the eccentric clamping collar 20 more robust. The angular spacing Ω, determined in this way, makes it possible to obtain a stronger resultant force than could be obtained for greater angular spacings, for example 120°. On the other hand, smaller values of the angular spacing would make the locking system according to the present disclosure less well balanced, since the forces acting between the shaft and the inner ring are not equidistant and balanced, and therefore less suitable for applications in which the shaft can rotate in both directions of rotation. In embodiments, a means for locking an inner ring to a shaft includes a collar, e.g., 20 in combination with two fasteners, e.g., pressure screws, e.g., 21, 22, assembled as described in the foregoing paragraph.

By means of this solution, it is possible to overcome the limitation of eccentric clamping collars, namely the fact that their use is limited to applications in which the direction of the shaft is always the same. In fact, the presence of two pressure screws makes the clamping collar suitable for use even when the rotation of the shaft is alternating.

The main advantage of this new locking system is the greater gripping force of the bearing unit, since the eccentric clamping collar is locked in a more robust way on the rotating shaft. The dimensions of the pressure screws and their clamping torque are no different from a single pressure screw solution, but the presence of an additional pressure screw improves the performance of the locking system as a whole.

In addition to the embodiments of the disclosure as described above, it is to be understood that numerous other variants exist. It is also to be understood that said embodiments are provided solely by way of example and do not limit the object of the disclosure or its applications or its possible configurations. On the contrary, although the description given above enables those skilled in the art to implement the present disclosure according to at least one example of its configurations, it is to be understood that numerous variations of the components described may be envisaged without thereby departing from the object of the disclosure as defined in the appended claims, interpreted literally and/or according to their legal equivalents.

1. A bearing unit comprising:
a stationary radially outer ring;
a radially internal ring, configured to rotate around a central rotation axis (Y) of the bearing unit;
at least one row of rolling elements interposed between the radially outer ring and the radially inner ring;
an eccentric collar configured for tightening the radially inner ring on a rotating shaft (S);
a first fastener on the eccentric collar, wherein the eccentric collar is provided with a second fastener which increases the gripping capacity of the bearing unit on the rotating shaft (S).

2. The bearing unit according to claim 1, wherein said first fastener and said second fastener are pressure screws.

3. The bearing unit according to claim 1, wherein said first fastener and said second fastener are arranged according to an angular distance (Ω) comprised between 57° and 67°.

4. The bearing unit according to claim 1, wherein said first fastener and said second fastener are arranged according to an angular distance (Ω) equal to 62°.

5. The bearing unit according to claim 1, wherein the radially inner ring comprises an end edge and a radially outer cylindrical surface having an eccentricity (E) with respect to the central rotation axis (Y) of the bearing unit.

6. The bearing unit according to claim 5, wherein the eccentric collar comprises an end edge and a radially internal cylindrical surface having the eccentricity (E) with respect to a rotation axis (Z) of the eccentric collar.

7. The bearing unit according claim 5, wherein the eccentricity (E) is between 3% and 4% of the diameter value (C) of a radially internal cylindrical surface of the radially inner ring.

8. The bearing unit according claim 6, wherein the eccentricity (E) is between 3% and 4% of the diameter value (C) of a radially internal cylindrical surface of the radially inner ring.

9. An assembly method of a bearing unit, the bearing unit comprising: a stationary radially outer ring; a radially internal ring, configured to rotate around a central rotation axis (Y) of the bearing unit; at least one row of rolling elements interposed between the radially outer ring and the radially inner ring; an eccentric collar configured for tightening the radially inner ring on a rotating shaft (S); a first pressure means on the eccentric collar, wherein the eccentric collar is provided with a second pressure means which increases the gripping capacity of the bearing unit on the rotating shaft (S), the method comprising:
resting a radially internal cylindrical surface of the eccentric collar on a radially external cylindrical surface of the radially inner ring;
rotating the eccentric collar until it interferes with the rotating shaft (S), creating a contact area (I) between the radially internal cylindrical surface of the eccentric collar and the rotating shaft (S);
positioning said first pressure means and said second pressure means in an opposite position with respect to the contact area (I) at a predetermined angular distance (Ω);
tightening said first pressure means and said second pressure means which will hold the rotating shaft (S), so that the forces (F1 and F2) generated by said first pressure means and said second pressure means are inside the contact area (I).

10. A bearing assembly comprising:
a means for locking an inner ring to a shaft.
